(19) United States
(12) Patent Application Publication
(10) Pub. No.: US 2026/0340344 A1
(43) Pub. Date: Oct. 29, 2026

(54) UTILIZING META AGENTS TO MODIFY THE BEHAVIOR OF LARGE LANGUAGE MODEL-BASED AGENTS

(71) Applicant: Character Technologies Inc., Palo Alto, CA (US)

(72) Inventor: Maor Bril, San Jose, CA (US)

(21) Appl. No.: 19/193,627

(22) Filed: Apr. 29, 2025

(51) Int. Cl. G06N 3/045

(52) U.S. Cl. CPC G06N 3/045

(57) ABSTRACT

A selection of a world is received. An instance of the world is instantiated based on settings included in the selection. The instance of the world includes a plurality of agents, each of the plurality of agents sharing a corresponding implicit shared memory with one or more meta agents. Each agent of the plurality of agents and each of the one or more meta agents is an instance of a corresponding large language model. A live stream of the instance of the world is provided based on corresponding outputs associated with the plurality of agents.

### BACKGROUND OF THE INVENTION

A large language model (LLM) is trained to be helpful, engaging, and aligned with user expectations. In some scenarios, such as a game in which artificial intelligence (AI) agents interact with each other and with users, such behavior can be too “people-pleasing” and come at the detriment of necessary ingredients for a good story like excitement, suspense, and conflict. One way to create interesting worlds and games as such may be to provide the agents with more descriptive prompts. However, over-prompting can lead to a story that is too prescriptive or predictable, which is likewise detrimental to engagement and potential user interactions. Under-prompting, on the other hand, can lead to agents wandering around without ever reaching any sort of resolution.

### BRIEF DESCRIPTION OF THE DRAWINGS

Various embodiments of the invention are disclosed in the following detailed description and the accompanying drawings.

FIG. 1A illustrates an embodiment of a system for utilizing meta agents to modify the behavior of LLM-based agents.

FIG. 1B is a block diagram illustrating a generated world in accordance with some embodiments.

FIG. 2 is a flow diagram illustrating a process in which a world is instantiated and a live stream associated with a plurality of agents in the world is provided according to some embodiments.

FIG. 3 is a flow diagram illustrating a process in which an order agent interacts with character agents in a world to help reach a particular endgame in accordance with some embodiments.

FIG. 4 is a flow diagram illustrating a process in which a chaos agent interacts with character agents in a world to add conflict in accordance with some embodiments.

FIG. 5 is a flow diagram illustrating a process in which a character agent executes actions of a plurality of actions in accordance with some embodiments.

FIG. 6 provides an example of a user interface for selecting a world.

FIG. 7A illustrates an example of a form for creating a world based on user inputs.

FIG. 7B illustrates an example of a form for creating a world with user inputs.

FIG. 8 provides an example of a user interface generated when a world is created.

FIG. 9 provides an example of a user interface generated when a world is created with a live feed of updates.

FIG. 10 provides an example of a detailed live update at a specific time interval associated with a world.

FIG. 11 provides an example of a generated image of a character agent and a prompt associated with the image.

FIG. 12 provides an example of a character-focused interface.

FIG. 13 provides an example of multiple characters' interactions at a given time interval.

FIG. 14 provides an example of a user interface to select a location-focused view.

FIG. 15A provides an example of a description of a world provided when a world is created and a button to play a greeting.

FIG. 15B provides an example of a display generated when a world is created.

FIGS. 16A-16J provide example screenshots from a video generated when a world is created.

FIG. 17 provides an example of a character's inner dialogue and interactions at a given time interval.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods of utilizing meta agents to modify the behavior of LLM-based agents are disclosed. LLM-based agents may be useful in producing humanlike dialogue between characters in a game or story. The “people-pleasing” behavior often exhibited by LLMs can lead to such games or stories being boring to a user or otherwise feeling overly scripted. A solution to this “people-pleasing” behavior includes providing additional context in the prompt to the LLM to add necessary conflict or intrigue while remaining on track toward a clear resolution. This can be done with meta agents that modify an LLM-based agent's actions based on instructions to add the necessary conflict or intrigue while remaining on track toward a clear resolution.

A world is instantiated based on user selections in a user interface on a client device. The world may be associated with a game, a popular television show, or some other premise. The instantiated world includes an order meta agent, a chaos meta agent, and a plurality of LLM-based agents.

An order meta agent receives a prompt including the user selections associated with the world, high-level descriptions of the story, narration style, and characters in the user selections, and instructions to generate a unique world and introduction with a backstory, aesthetic, overall description of the world and characters, and overarching goals, or an endgame, to be reached in a certain number of time steps. In response to receiving the prompt, the order meta agent generates a unique world each time a world is selected by a user.

The generated world is associated with a plurality of time steps. At each time step, each agent, using its associated LLM, generates and stores in an implicit shared memory one or more actions including interacting with an object, talking to another agent, moving to another location, saying internal dialogue, and/or some other action that fits within the time step. The implicit shared memory is shared between an LLM-based agent, an order meta agent, and a chaos meta agent. However, the LLM-based agent remains unaware that the order meta agent and the chaos meta agent have access to the implicit shared memory. By sharing implicit memory with meta-agents, the LLM-based agent benefits from more efficient coordination, decision-making, and optimization within a multi-agent system. Implicit shared memory enables instant data access, eliminating the need for explicit communication, which significantly reduces latency compared to traditional message-passing systems.

Additionally, redundant data storage is minimized by maintaining a single shared copy of the one or more actions, effectively reducing the overall memory footprint. The order and chaos meta agents can continuously monitor agent states, actions, and goals without requiring explicit requests, further eliminating communication delays.

As the LLM-based agent shares its learned experiences, the meta agents can coordinate and optimize actions to prevent redundancy. Moreover, the order and chao meta agents can override or adjust agent behaviors in real time by monitoring agent states, detecting issues, and making dynamic adjustments. This eliminates the need for back-and-forth messaging, making the system more responsive and self-healing (e.g., guiding the agent efficiently towards the endgame).

At each time step, an order meta agent and chaos meta agent are prompted to access the implicit shared memories, and modify or leave alone each action planned by each agent for the subsequent time step. The order meta agent is prompted to modify an agent's actions stored in the implicit shared memory based on a determination that the agent is not behaving in a way that will progress the world toward the determined endgame within the determined number of time steps constituting the lifespan of the world. The chaos meta agent is prompted to modify an agent's actions stored in the implicit shared memory based on a determination that additional conflict or intrigue is needed for the story to remain interesting.

If the agent does not need to explicitly process or respond to changes in shared memory, it can continue its tasks without unnecessary interruptions. By avoiding the overhead of processing meta-agent interventions, agents can remain focused on their objectives without wasting resources. Additionally, an agent that is unaware of meta-agent modifications will not resist or override them, leading to smoother coordination. Without the need to wait for explanations or handle explicit updates, agents can react more quickly to changes.

Creating a world of LLM-based agents guided by order and chaos meta agents as disclosed herein improves the “people-pleasing” behavior of LLMs to progress a story toward a clear resolution while providing conflict and intrigue to keep the story unique and interesting.

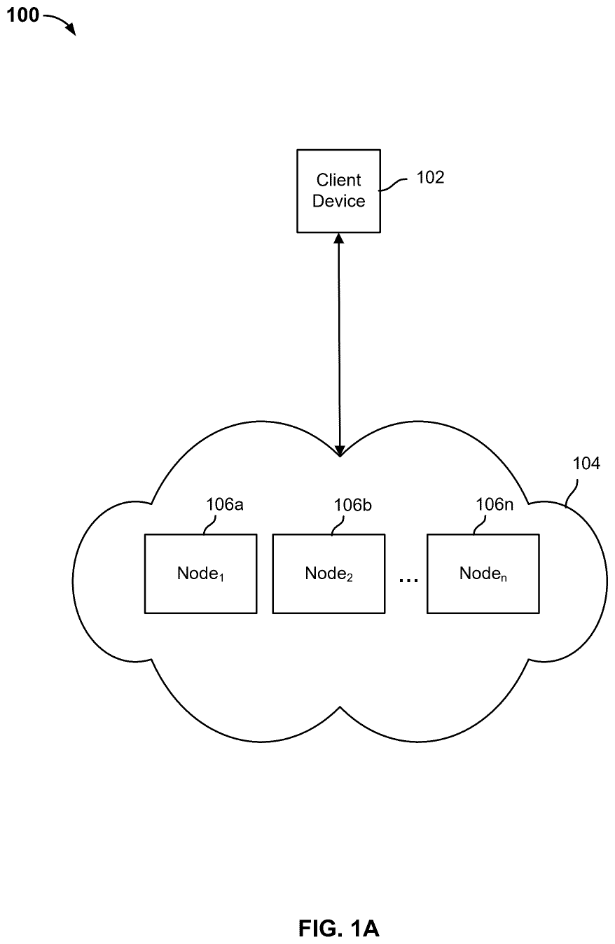

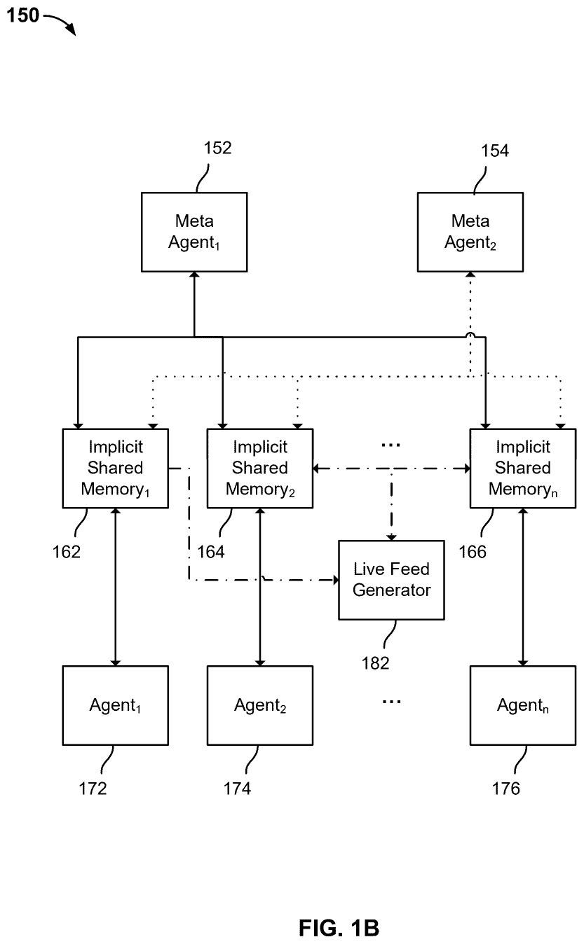

FIG. 1A illustrates an embodiment of a system for utilizing meta agents to modify the behavior of LLM-based agents. In the example shown, system 100 includes client device 102, cloud computing service 104, and one or more nodes 106a-106n hosted on cloud computing service 104. Client device 102 may be a computer, a server, a smartphone, a laptop, a tablet, a smartwatch, or any other electronic device capable of communicating with a cloud-based server. In some embodiments, client device 102 is a client device associated with a human user. Cloud computing service 104 may be a provider such as Amazon Web Services, Microsoft Azure, Google Cloud Platform, or any other cloud computing service that offers hosted servers and database storage.

Each node of the one or more nodes 106a-106n is a server or virtual machine (VM) hosted on cloud computing service 104. For example, a node may provide the necessary compute resources to run one or more Kubernetes pods, each node containing one or more worlds.

Client device 102 communicates with cloud computing service 104 over a network through a network connection protocol. The network connection protocol may be a WebSocket, MQTT, WebRTC, SSE, or some other network connection protocol.

To generate a world, client device 102 sends a request to a web browser. In response, an instance the selected world is generated on one of the nodes 106a-106n. The generated world includes a first meta agent, a second meta agent, a plurality of agents, and a plurality of implicit shared memories. The world refers to the setting, environment, and underlying reality in which a story or game takes place. It encompasses everything from the physical landscape and culture to the rules, history, and logic that govern the narrative space.

Elements associated with a world include a physical setting, rules and laws, culture & society, history & lore, technology & economy, characters & creatures, and/or conflict & tension.

In some embodiments, a world is associated with a game or a story. For example, the world may be an instance of a game of Clue. In this example, the plurality of agents is associated with a plurality of characters in the game of Clue (e.g., Miss Scarlett, Professor Plum, Colonel Mustard, etc.).

When a user selects the same world multiple times, or when different users select the same world, the world may be a different each time it is instantiated. For example, although the game of Clue may have the same premise and overall objective in every instance (i.e., discover who committed a murder with which weapon and in which room), the story may end up having a different resolution in each separate instance (e.g., user A may play a game with the conclusion “Miss Scarlett with the candlestick in the living room,” user B may play a game with the conclusion “Professor Plum with the revolver in the kitchen,” and user A may play a subsequent game with the conclusion “Colonel Mustard with the candlestick in the lounge,” etc.).

FIG. 1B is a block diagram illustrating a generated world in accordance with some embodiments. World 150 is generated on one of the nodes 106a-106n. In the example shown, world 150 includes meta agent 152 and meta agent 154, implicit shared memories 162, 164, and 166, agents 172, 174, and 176, and live feed generator 182. Although FIG. 1B illustrates world 150 as having three agents and three implicit shared memories, world 150 may include 1:n agents and 1:n implicit shared memories where each agent has a corresponding implicit shared memory.

Meta agent 152 is an instance of an LLM. Meta agent 152 may receive contextual information regarding the world including the premise, the backstory, the setting of the world, and/or the narrative style.

Based on the contextual information, meta agent 152 is configured to generate an endgame and lifespan for the world. The endgame is an outcome of the entire story that clearly resolves a key objective associated with the world. The lifespan is the number of time steps taken to reach the endgame. For example, if the world is a game of Clue, the endgame will be the answer to “who is the murderer and what weapon did they use in which room of the house?” In some embodiments, the endgame occurs in the final time step of the world. In some embodiments, the endgame occurs before the final time step (e.g., the penultimate time step). This allows for the aftermath after the endgame to be discussed.

Meta agent 152 is configured to, at each time step, either modify or leave unchanged a planned action in the sequence of actions associated with each of one or more agents 172, 174, and 176. An action may include one or more of interacting with an object, talking to another agent, moving to another location within the world, saying internal dialogue, or some other action that fits within the time step. The duration that a time step represents may be determined by the user or generated by meta agent 152.

In some embodiments, the length of a time step in the world is the same as the length of a time step in real time (i.e., the time interval a human user experiences). In some embodiments, the length of a time step in the world is different from the length of a time step in real time. For example, a time step in real time may be configured to be one minute, but each time step in the world represents an hour. In this example, a user would be seeing updates about the world every minute, and each update would constitute an hour's worth of actions taken by the agents in the world.

In some embodiments, meta agent 152 modifies a planned action according to a prompt. The prompt may be configured to describe how and how often meta agent 152 should modify a planned action associated with the plurality of agents 172, 174, and 176. In some embodiments, the prompt is provided in a request from a client device such as client device 102 to a cloud computing service such as cloud computing service 104. In some embodiments, the prompt is associated with a specific world and provided by the developer to be stored on one or more nodes such as nodes 106a-106n hosted on the cloud computing service.

The prompt may describe an objective of reaching the endgame within a certain number of time steps. The prompt may also provide context about how many times meta agent 152 has modified a planned action as well as what the modification was and which agent the action was associated with.

The prompt may include further instructions to restrict the amount of times meta agent 152 is able to modify a planned action in the sequence of actions associated with each of the one or more agents 172, 174, and 176. Such a prompt will help keep the world interesting and not overly scripted while still supporting the overall plot in reaching an eventual resolution.

Meta agent 154 is another instance of an LLM. Meta agent 154 is also provided with contextual information regarding the world including the premise, the backstory, the setting of the world, and/or the narrative style.

Meta agent 154 is configured to, at each time step, either modify or leave unchanged a planned action in the sequence of actions associated with each of one or more agents 172, 174, and 176. An action may include one or more of interacting with an object, talking to another agent, moving to another location, saying internal dialogue, or some other action that fits within the time step.

In some embodiments, meta agent 154 modifies the internal dialogue of an agent according to a prompt. The prompt may be configured to describe how and how often meta agent 154 should modify the planned action. In some embodiments, the prompt is provided in a request from a client device such as client device 102 to a cloud computing service such as cloud computing service 104. In some embodiments, the prompt is associated with a specific world and provided by the developer to be stored on one or more nodes such as nodes 106a-106n hosted on the cloud computing service.

The prompt may describe an objective of adding conflict or intrigue. The prompt may also provide context about how many times meta agent 154 has modified a planned action as well as what the modification was and which agent the action was associated with. Unlike meta agent 152, meta agent 154 is not provided context about the endgame.

The prompt may include further instructions to restrict the amount of times meta agent 154 is able to modify a planned action in the sequence of actions associated with each of the one or more agents 172, 174, and 176. Such a prompt will help keep the world engaging without introducing too much conflict.

Agents 172, 174, and 176 are each an instance of an LLM. Each agent is associated with a character (e.g., in a world for the game of Clue, there is an agent for Miss Scarlett, an agent for Professor Plum, an agent for Colonel Mustard, etc.). A world contains a plurality of agents.

Each agent is configured to, at each time step, plan one or more actions for the next time step. An action may include one or more of interacting with an object, talking to another agent, moving to another location, saying internal dialogue, or some other action that fits within the time step.

To generate one or more planned actions for the next time step, the agent receives a prompt with an instruction to generate a plurality of actions based on context about the world, where the context includes the agent's past actions, the overall premise of the story, the location the agent is currently in, the other agents at that location, the current time step, as well as any other relevant information.

The agent is not provided with knowledge regarding the existence of meta agent 152 and meta agent 154. The agent is also unaware of neither the actions of agents outside of its current location nor the internal dialogue of any other agent.

At a given time step, each agent adds its planned actions to a corresponding implicit shared memory associated with the agent. In the example shown, agent 172 is associated with implicit shared memory 162, agent 174 is associated with implicit shared memory 164, and agent 176 is associated with implicit shared memory 166.

The agent is configured to provide planned actions that will fit within the given time step. For example, if the time step is a minute, the action may be to approach another character or provide two sentences of internal dialogue, but it would not be to run a marathon. Similarly, if the time step is one hour, the action or actions will fill an hour. For example, the planned actions may be to take a walk around the park or a series of actions such as playing a card game and then tending to the garden.

An implicit shared memory is a sequence of actions associated with a single agent. In some embodiments, the implicit shared memory is an in-memory database such as Redis configured to store a sequence of actions associated with an agent.

In modifying an agent's planned action, meta agent 152 or meta agent 154 will replace the agent's planned action for the subsequent time step with the modified action. The agent is unaware that meta agent 152 or meta agent 154 modified their planned action.

In the subsequent time step, the agent will perform the action present in the implicit shared memory, which may be either the agent's originally planned action or the modified action determined by meta agent 152 or meta agent 154.

The implicit shared memory therefore serves two purposes. First, it stores the planned action for the meta agents to determine whether or not it should be modified before an agent outputs an action. Second, it serves as a memory store for historical context for both agents and meta agents to use in determining future behavior at the subsequent time step.

As such, the meta agents improve the default behavior of the LLMs by providing additional considerations as context to the generation of character behavior and guiding the character agents toward the world's endgame while creating conflict and intrigue. That is, a modification made by a meta agent may steer an LLM-based agent towards a resolution; one that the LLM-based agent might not have achieve without the meta agent's intervention.

At a given time step, meta agent 152 and meta agent 154 may attempt to modify the same planned action. In this case, either the modification from meta agent 152 or the modification from meta agent 154 will be made.

Live feed generator 182 is configured to provide to the user, at each time step, a live feed of the actions taken by the agents at the time step. The live feed includes a description of the state of the world at the time step. In some embodiments, the live feed is a detailed description of the actions and inner dialogues of each agent. In some embodiments, the live feed is a partial description of the actions and inner dialogues of each agent. In some embodiments, the live feed is a summary of the actions and inner dialogues of each agent.

In some embodiments, the live feed includes the description of the state of the world and one or more generated images associated with the description. In some embodiments, the live feed includes the description of the state of the world and one or more generated videos associated with the description. In some embodiments, the live feed includes the description of the state of the world and an audio recording of the description.

In some embodiments, the meta agents, implicit shared memories, agents, and live feed generator constitute the world hosted on a single node of the one or more nodes 106a-n.

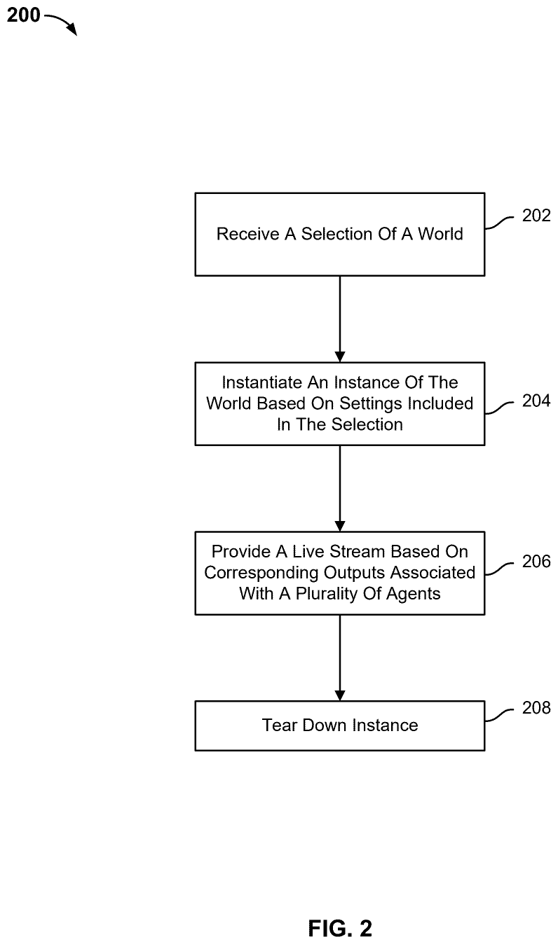

FIG. 2 is a flow diagram illustrating a process in which a world is instantiated and a live stream associated with a plurality of agents in the world is provided according to some embodiments. Process 200 may be performed by one or more nodes such as nodes 106a-n hosted on a cloud computing service such as cloud computing service 104.

At 202, a selection of a world is received. The selection may be received from a client device such as client device 102. The world may be selected by a human user using the client device. In some embodiments, a world is associated with a game. For example, the world may be an instance of a game of Clue. In this example, the plurality of agents is associated with a plurality of characters in the game of Clue (e.g., Miss Scarlett, Professor Plum, Colonel Mustard, etc.).

In some embodiments, the world is associated with a story. For example, the world may be a fantasy scene like “The Last Train to Everforest.” In this example, a plurality of agents is associated with a plurality of mythical characters in an enchanted wilderness.

At 204, an instance of the world is instantiated based on settings included in the selection. In some embodiments, the settings included in the selection are a name for the world, the user's name, one or more characters to be included in the world, and a narration style.

Some or all of step 204 may be performed by one or more nodes such as nodes 106a-106n hosted on the cloud computing service. The one or more nodes may instantiate the world based on the settings included in the selection of the environment as well as a high-level premise and backstory specific to the selection and a high-level description of the selected characters. Instantiating a world may further include generating an introduction, backstory, aesthetic, overall description of the world and characters, and overarching goals. Generating the world may further include determining the length of a time step (i.e., the duration of a time interval in which an agent performs actions).

In some embodiments, generating an introduction, backstory, aesthetic, overall description of the world and characters, and overarching goals is performed using an instance of an LLM on the one or more nodes.

Instantiating an instance of the world in this manner allows for a unique world to be created each time a world is selected. For example, if a user is to select the game of Clue as a world at step 202 two separate times, the instance of the world instantiated in step 204 may result in two different storylines, locations, character actions, narration styles, and resolutions even though the high-level objective (i.e., discover who committed a murder with which weapon and in which room) remains the same.

The instance of the world includes a plurality of characters selected by the user as part of the settings included in the selection of the world. A plurality of agents such as agents 172, 174, and 176 is also instantiated, where each agent is an instance of an LLM and is associated with a character of the plurality of characters (e.g., in a world for the game of Clue, there is an agent for Miss Scarlett, an agent for Professor Plum, an agent for Colonel Mustard, etc.).

A plurality of prompts is provided to a plurality of agents associated with the plurality of characters. In some embodiments, the plurality of prompts is associated with the world and provided by the developer to be stored on one or more nodes such as nodes 106a-106n hosted on the cloud computing service. In some embodiments, the plurality of prompts is generated by the meta agent along with the world.

Each prompt may include an instruction to generate a plurality of actions based on context about the world, where the context includes the agent's past actions, the overall premise of the story, the location the agent is currently in, the other agents at that location, the current time step, as well as any other relevant information.

The agents are not provided with knowledge regarding the existence of meta agent 152 and meta agent 154. The agents are also unaware of neither the actions of agents outside of its current location nor the internal dialogue of any other agent.

Each agent is configured to, at each time step, plan one or more actions for the next time step based on the prompt. An action may include one or more of interacting with an object, talking to another agent, moving to another location, saying internal dialogue, or some other action that fits within the time step.

At a given time step, each agent is configured its planned actions to the corresponding implicit shared memory associated with the agent.

At 206, a live stream is provided based on corresponding outputs associated with a plurality of agents. The live stream may be provided by a live feed generator such as live feed generator 182.

The corresponding outputs associated with a plurality of agents may be sequences of actions stored in implicit shared memories such as implicit shared memories 162, 164, and 166 associated with a plurality of agents such as agents 172, 174, and 176, respectively.

In some embodiments, the live stream is a detailed description of the actions and inner dialogues of each agent. In some embodiments, the live stream is a partial description of the actions and inner dialogues of each agent. In some embodiments, the live stream is a summary of the actions and inner dialogues of each agent.

In some embodiments, the live stream is updated at each time step in real time. In some embodiments, the length of a time step in the world is the same as the length of a time step in real time (i.e., the time interval a human user experiences). In some embodiments, the length of a time step in the world is different from the length of a time step in real time. For example, a time step in real time may be configured to be one minute, but each time step in the world represents an hour. In this example, the live stream would provide updates about the world every minute, and each update would constitute an hour's worth of actions taken by the agents in the world.

At 208, the instance of the environment is torn down. In some embodiments, the instance is torn down when the final time step has been completed and the world ends. In some embodiments, the instance is torn down when the user leaves the application.

Tearing down the instance may include saving the current state of the world, shutting down the server or VM to free up compute resources, and storing or removing any relevant logs.

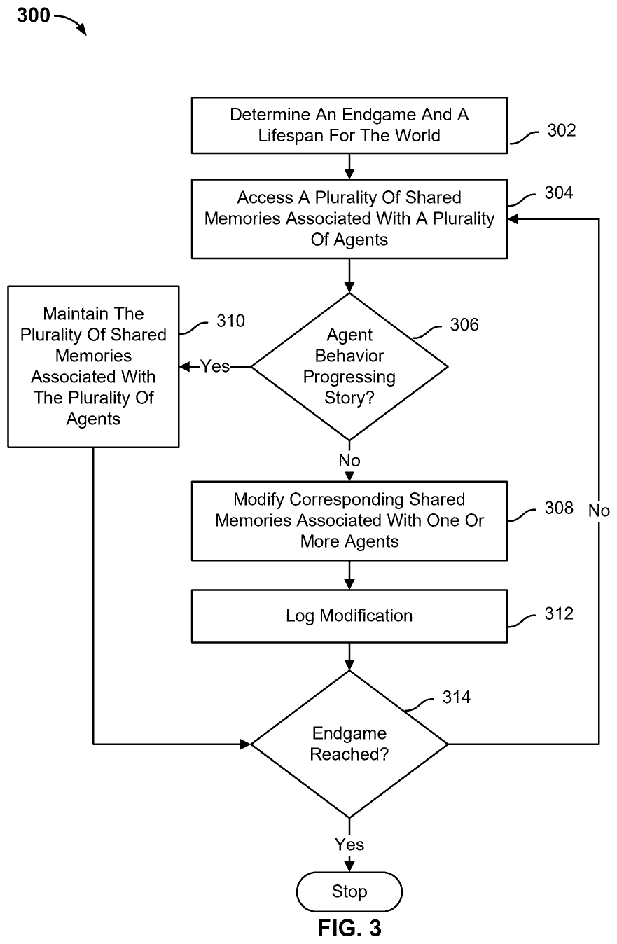

FIG. 3 is a flow diagram illustrating a process in which an order agent interacts with character agents in a world to help reach a particular endgame in accordance with some embodiments. Process 300 may be performed by a meta agent such as meta agent 152.

At 302, an endgame and a lifespan for the world are determined. The endgame is an outcome of the entire story that clearly resolves a key objective. The lifespan is the number of time steps taken to reach the end of the world. For example, if the world is a game of Clue, the endgame will be the answer to “who is the murderer and what weapon did they use in which room of the house?” In some embodiments, the endgame occurs in the final time step of the world. In some embodiments, the endgame occurs before the final time step.

The endgame for the world may be a different each time it is determined. For example, although the game of Clue may have the same premise and overall objective in every instance (i.e., discover who committed a murder with which weapon and in which room), the story may end up having a different endgame in each separate instance (e.g., user A may play a game with the endgame “Miss Scarlett with the candlestick in the living room,” user B may play a game with the conclusion “Professor Plum with the revolver in the kitchen,” user A may play a subsequent game with the endgame “Colonel Mustard with the candlestick in the lounge,” etc.).

At 304, a plurality of shared memories associated with a plurality of agents is accessed. The plurality of agents may be agents such as agents 172, 174, and 176 associated with the plurality of characters in the world. The plurality of shared memories may be implicit shared memories such as implicit shared memories 162, 164, and 166.

A shared memory of the plurality of shared memories may include a sequence of actions associated with a single agent. An action may include one or more of interacting with an object, talking to another agent, moving to another location, saying internal dialogue, or some other action that fits within the time step. At a given time step, the most recent action (i.e., the planned action for the subsequent time step) is accessed in the sequence of actions associated with each agent's shared memory.

At 306, it is determined whether agents' behaviors are progressing the story associated with the world toward the endgame determined at 302 within the lifespan determined at 302. The prompt may include context about the current agent behavior based on the histories of planned actions stored in the plurality of shared memories. In response to a determination that one or more of the agents' behaviors are not progressing the story, process 300 proceeds to 308. In response to a determination that the agents' behaviors are not progressing the story, process 300 proceeds to 310 where the plurality of shared memories associated with the plurality of agents is maintained.

At 308, corresponding shared memories associated with one or more agents are modified based on the most recent action (i.e., the planned action for the subsequent time step). Modifying a shared memory may include modifying a planned action associated with the shared memory according to a prompt. In some embodiments, the prompt is associated with a specific world and provided by the developer to be stored on one or more nodes such as nodes 106a-106n hosted on the cloud computing service. The prompt may be configured to describe how and how often the meta agent should modify the planned action.

The prompt may describe an objective of reaching the endgame within the lifespan of the world. The prompt may also provide context about how many times the meta agent has previously modified a planned action as well as what the modification was and which agent the action was associated with. The prompt may include further instructions to restrict the amount of times the meta agent is able to modify a planned action to a threshold number of times within a threshold number of time steps. As such, it may be the case that some of the corresponding shared memories associated with one or more agents are maintained even if improper agent behavior is determined.

For example, if the world is a game of Clue with an endgame of Miss Scarlett committing the murder with a candlestick in the living room and a lifespan of 30 time steps, at time step 20 it may be determined that the Professor Plum agent is not behaving properly if he has not yet started moving toward suspicion of Miss Scarlett. In this case, the meta agent may modify Professor Plum's next planned action to include traveling to the living room and discussing Miss Scarlett with another character.

In another example, the world may be at time step 15 out of a lifespan of 30 time steps. The meta agent may determine that an agent is not behaving properly, yet still decide not to modify the agent's planned actions based on the fact that it has already modified the agent's actions in several previous time steps. In this example, the meta agent, based on the prompt, is configured to act in a way that is not overly scripted.

At 312, the modifications are logged. The logged modifications are stored and may be included as part of the prompt at 308 to provide context about how many times the meta agent has previously modified a planned action as well as what the modification was and which agent the action was associated with.

At 314, it is determined whether the endgame is reached. In response to a determination that the endgame is reached, process 300 stops. In response to a determination that the endgame is not reached, process 300 returns to 304.

The world may continue running for one or more time steps after the endgame is reached depending on the lifespan determined at 302. In this case, the character agents may continue to plan and perform a plurality of actions at each remaining time step, but the meta agent will no longer modify the shared memories.

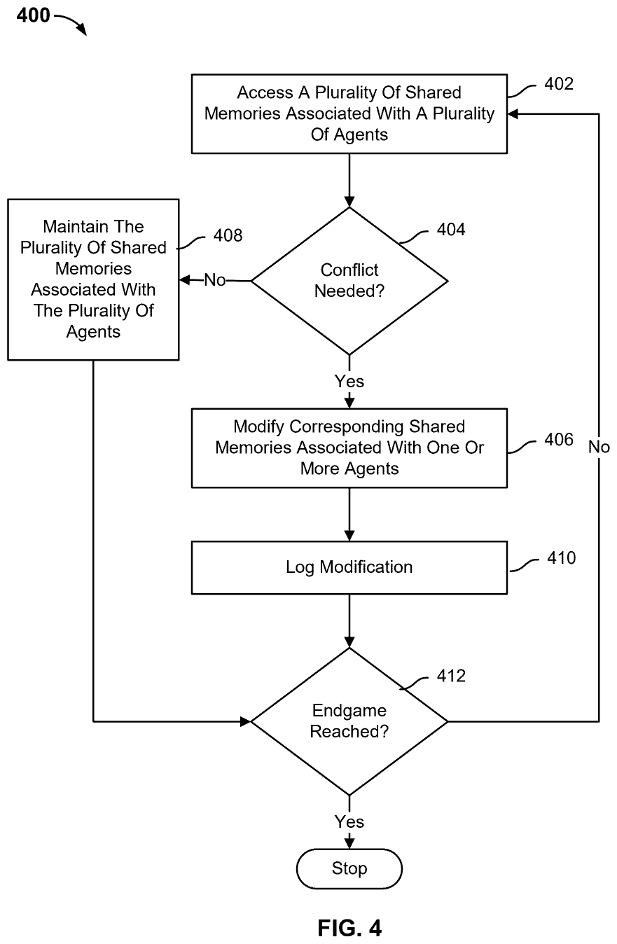

FIG. 4 is a flow diagram illustrating a process in which a chaos agent interacts with character agents in a world to add conflict in accordance with some embodiments. Process 400 may be performed by a meta agent such as meta agent 154.

At 402, a plurality of shared memories associated with a plurality of agents is accessed. The plurality of agents may be agents such as agents 172, 174, and 176 associated with the plurality of characters in the world. The plurality of shared memories may be implicit shared memories such as implicit shared memories 162, 164, and 166.

A shared memory of the plurality of shared memories may include a sequence of actions associated with a single agent. An action may include one or more of interacting with an object, talking to another agent, moving to another location, saying internal dialogue, or some other action that fits within the time step. At a given time step, the most recent action (i.e., the planned action for the subsequent time step) is accessed in the sequence of actions associated with each agent's shared memory.

At 404, it is determined whether conflict is needed based on a prompt. The prompt may instruct to determine whether conflict is needed based on the histories of planned actions stored in the plurality of shared memories. In response to a determination that conflict is needed, process 400 proceeds to 406. In response to a determination that conflict is not needed, process 400 proceeds to 408.

At 406, corresponding shared memories associated with one or more agents are modified based on the most recent action (i.e., the planned action for the subsequent time step). Modifying a shared memory may include modifying an agent's internal dialogue according to a prompt. The prompt may be configured to describe how and how often the meta agent should modify the planned action.

The prompt may also provide context about how many times the meta agent has previously modified a planned action as well as what the modification was and which agent the action was associated with. The prompt may include further instructions to restrict the amount of times the meta agent is able to modify a planned action to a threshold number of times within a threshold number of time steps. As such, it may be the case that some of the corresponding shared memories associated with one or more agents are maintained even if it is determined that conflict is needed.

For example, if the world is a game of Clue, it may be determined that conflict is needed if the shared memory of the Professor Plum character agent has only been modified a total of two times in the first ten time steps. The meta agent may then modify the internal dialogue of Professor Plum's next planned action to cast suspicion on another character (e.g., “what if Colonel Mustard is the murderer? I should start a conversation with him.”).

The meta agent is not provided context regarding the endgame of the world, and the determination that conflict is needed as well as the modification made is unrelated to the endgame of the world. As such, the added conflict serves to add intrigue or entertainment to the world regardless of whether it progresses the character agents toward the endgame determined by the other meta agent in process 300.

At 410, the modifications are logged. The logged modifications are stored and may be included as part of the prompt at 406 to provide context about how many times the meta agent has previously modified a planned action as well as what the modification was and which agent the action was associated with.

At 412, it is determined whether the endgame is reached. In response to a determination that the endgame is reached, process 400 stops. In response to a determination that the endgame is not reached, process 400 returns to 402.

The world may continue running for one or more time steps after the endgame is reached depending on the lifespan determined by the other meta agent at step 304 of process 300. In this case, the character agents may continue to plan and perform a plurality of actions at each remaining time step, but the meta agents will no longer modify the shared memories.

At 408, the plurality of shared memories associated with the plurality of agents is maintained.

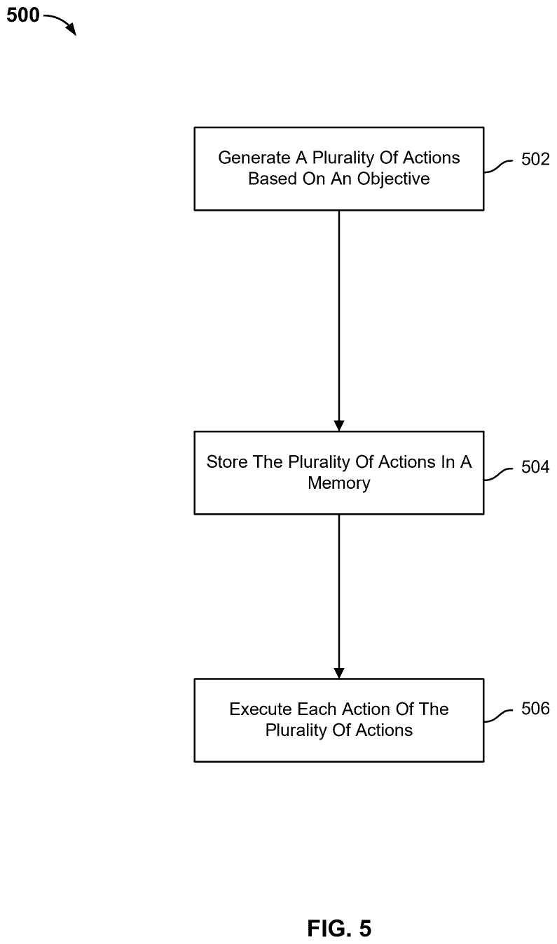

FIG. 5 is a flow diagram illustrating a process in which a character agent executes actions of a plurality of actions in accordance with some embodiments. Process 500 may be performed by an agent such as agent 172, 174, or 176.

At 502, a plurality of actions based on an objective is generated. An action may include one or more of interacting with an object, talking to another agent, moving to another location, saying internal dialogue, or some other action that fits within the time step. In some embodiments, the plurality of actions is generated to fit within a single time step. In some embodiments, the plurality of actions is generated to fit within a plurality of time steps.

In some embodiments, the objective is a high-level objective predetermined to be associated with a selected environment. In some embodiments, the objective is determined as part of instantiating an instance of the environment in step 204 of process 200.

At 504, the plurality of actions is stored in a memory. The memory may be an implicit shared memory such as one of implicit shared memories 162, 164, and 166. In some embodiments, the memory is a database. In some embodiments, the memory is another type of in-memory storage such as Redis or Memcache.

At 506, each action of the plurality of actions is executed. Executing each action may include providing a description of the action as part of a live stream such as the live stream provided in step 206 of process 200. At a given time step, the most recent action in the sequence of actions associated with each agent's shared memory. (i.e., the planned action for the subsequent time step) is executed.

The executed plurality of actions may be the original plurality of actions generated by the character agent at 502. The executed plurality of actions may also be a set of actions based on the original plurality of actions and modified by a meta agent such as meta agent (order) 152 or meta agent (chaos) 154 in step 310 or step 406, respectively.

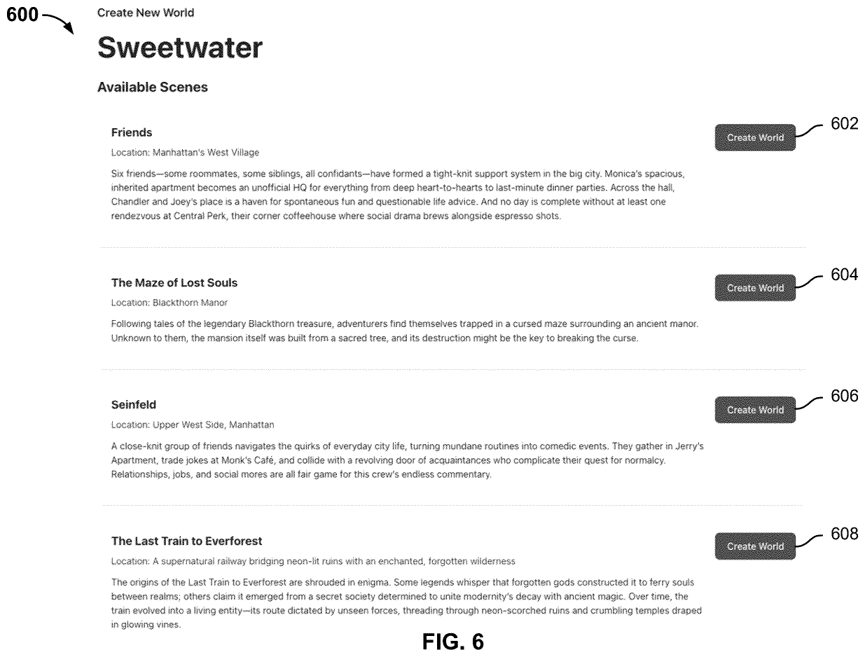

FIG. 6 provides an example of a user interface for selecting a world. In some embodiments, a user's choice according to a similar user interface may be associated with receiving a selection of a world at step 202 of process 200. When encountering user interface 600, the user may choose between worlds associated with well-known television shows (e.g., Friends 602, Seinfeld 606), fantasy storylines (e.g., The Maze of Lost Souls 604, The Last Train to Everforest 608), popular board games (e.g., Clue), or some other world in an “Available Scenes” menu. The resources associated with displaying each world on a client device, such as client device 102, associated with a user may be hosted on a node, such as nodes 106a-106n, on a cloud computing service, such as cloud computing service 104.

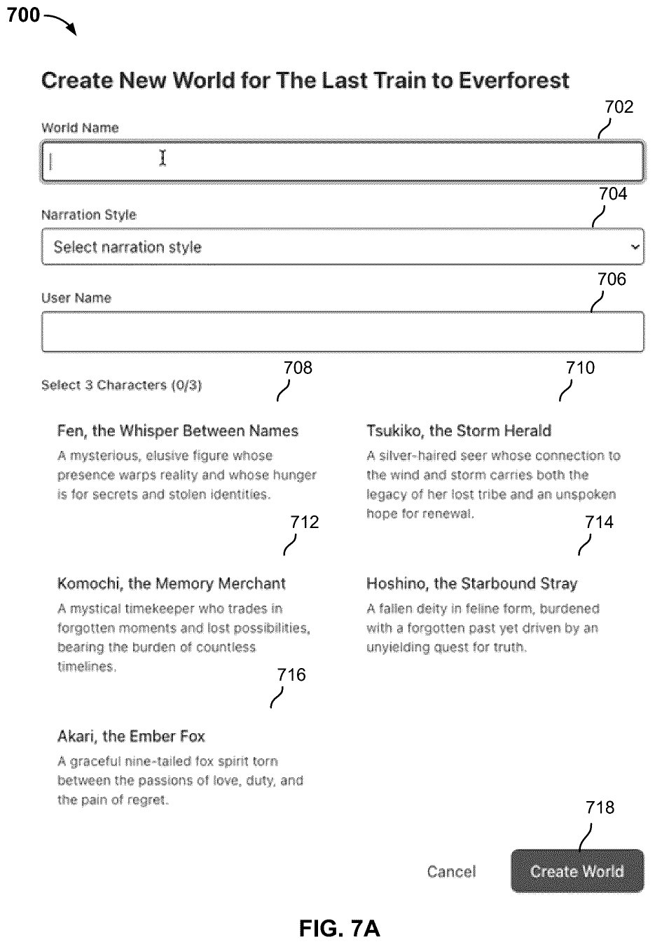

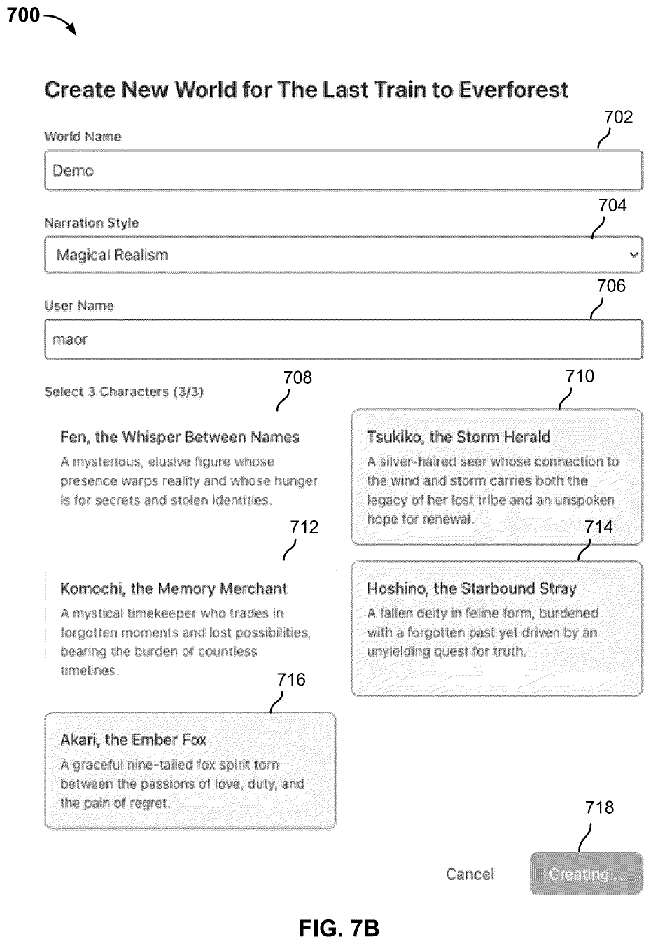

FIG. 7A illustrates an example of a form for creating a world based on user inputs. In some embodiments, a similar form may be used to include additional settings with the selection of a world in process 200.

In the example shown, a user may input a world name 702, narration style 704 (e.g., dramatic, grimdark, gothic, magical realism, NGL Cooked FR, silly), and user name 706, and select three characters from a plurality of options (708, 710, 712, 714, 716) associated with the world. Each character includes a high-level description.

When the user selects “Create World” button 718, an instance of the world based on the settings included in the selection will be instantiated, as in step 204 of process 200.

FIG. 7B illustrates an example of form 700 with user inputs. “Create World” button 718 has been selected, as well as user inputs for world name 702 (e.g., “Demo”), narration style 704 (e.g., “Magical Realism”), user name 706 (e.g., “maor”) and three characters 710 (“Tsukiko, the Storm Herald”), 714 (“Hoshino, the Starbound Stray”), and 716 (“Akari, the Ember Fox”).

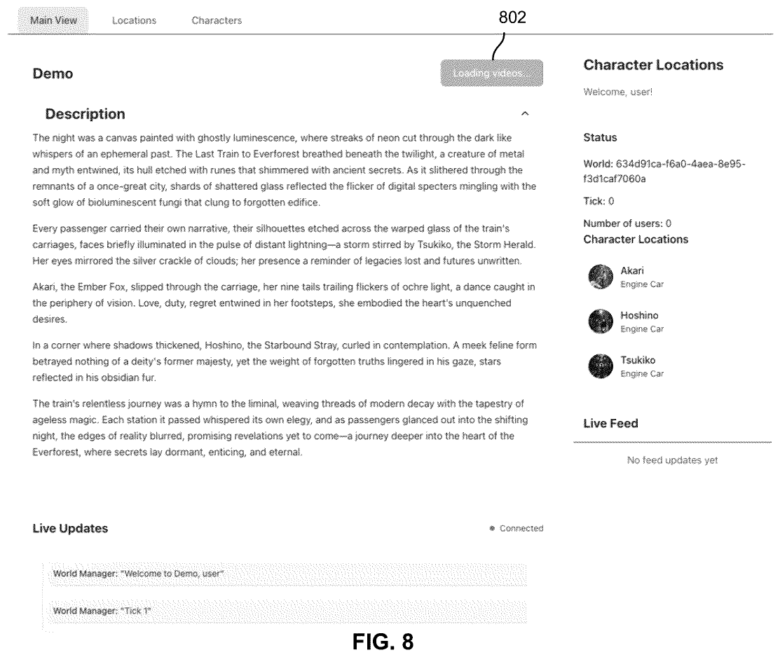

FIG. 8 provides an example of a user interface generated when a world is created. The example shown may appear on a client device associated with a user as a result of step 204 of process 200. The example shown includes a description of the world, a list of character locations, and a live updates feed. The current time step is “Tick: 0” as the world has recently been instantiated.

The example further includes a “Loading videos” indicator 802. In some embodiments, instantiating a world includes generating a video associated with a high-level description of the world.

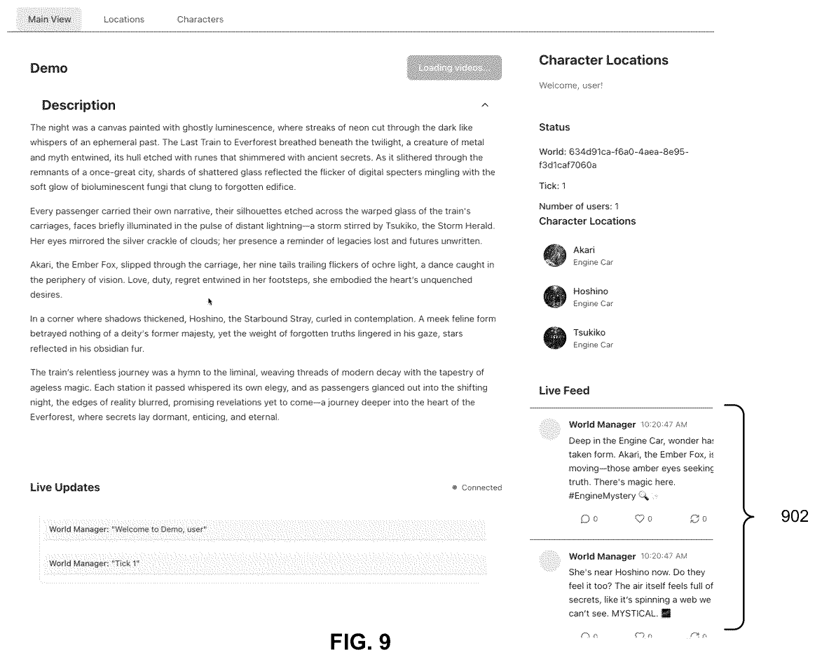

FIG. 9 provides an example of a user interface generated when a world is created with a live feed of updates. In the example shown, the live feed 902 includes short-form, social media-like updates with descriptions of character actions associated with the first time step. The live feed 902 may be generated by a live feed generator, such as live feed generator 182, and may be provided to a client device by step 206 of process 200.

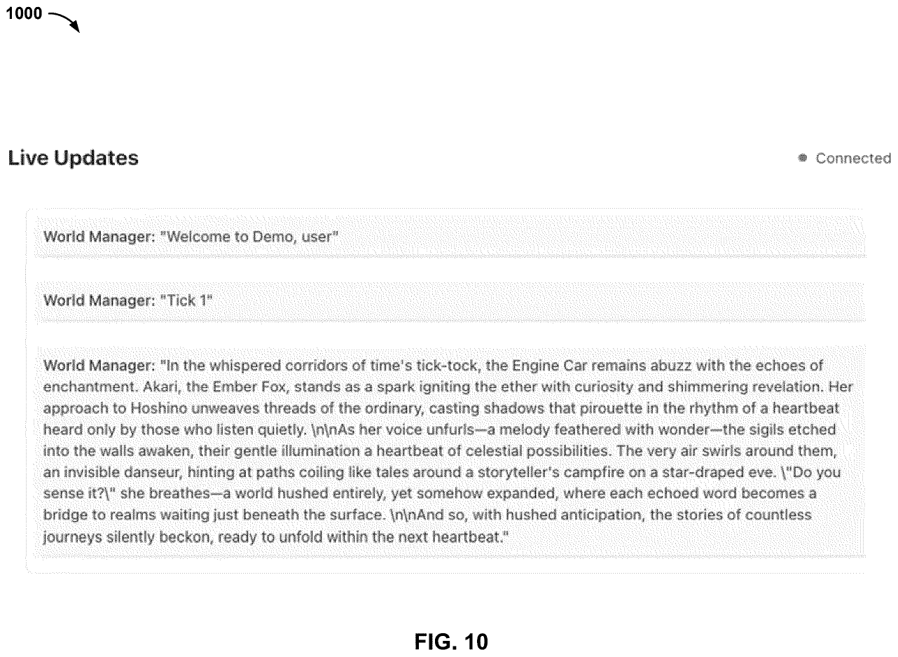

FIG. 10 provides an example of a detailed live update at a specific time interval associated with a world. In some embodiments, the live update 1000 at each time step is a high-level overview of the actions of the plurality of characters at that time step. In some embodiments, the live update is generated by a live feed generator, such as live feed generator 182, along with the live feed displayed in FIG. 9.

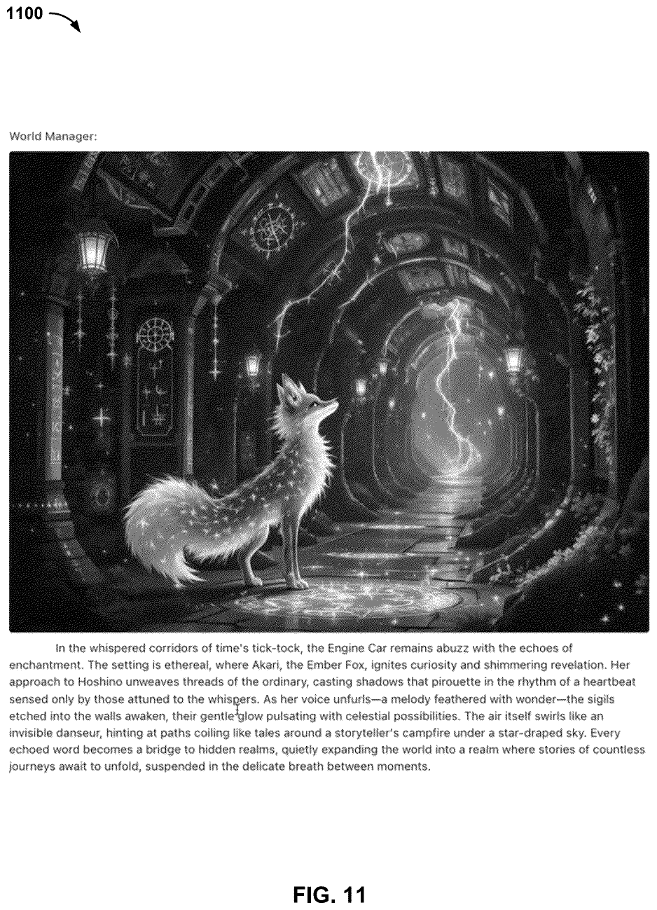

FIG. 11 provides an example of a generated image of a character agent and a prompt associated with the image. The image 1100 may be generated along with the live feed by a live feed generator such as live feed generator 182. The prompt associated with the image may be used as part of all of the instruction for generating the image. In some embodiments, the prompt associated with the image is displayed to the user. In some embodiments, the prompt associated with the image is hidden from the user.

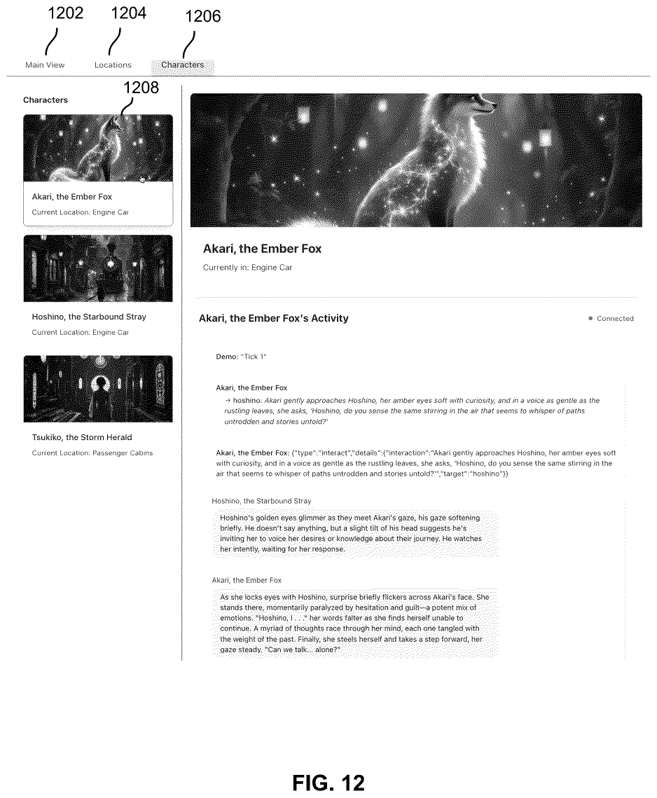

FIG. 12 provides an example of a character-focused interface. The character-focused is displayed when a user clicks “Characters” tab 1206 from the selection of “Main View” 1202, “Locations” 1204, and “Characters” 1206.

In the example shown, the character “Akari, the Ember Fox” is selected. A character may be selected when a user clicks the corresponding button, such as button 1208.

When a character is selected, a user is provided with the name of the selected character, the location of the selected character at the current time step, and a list of actions taken by the selected character through the current time step including actions taken by characters interacting with the selected character in the same location. An action may include one or more of interacting with an object, talking to another agent, moving to another location, saying internal dialogue, or some other action that fits within the time step.

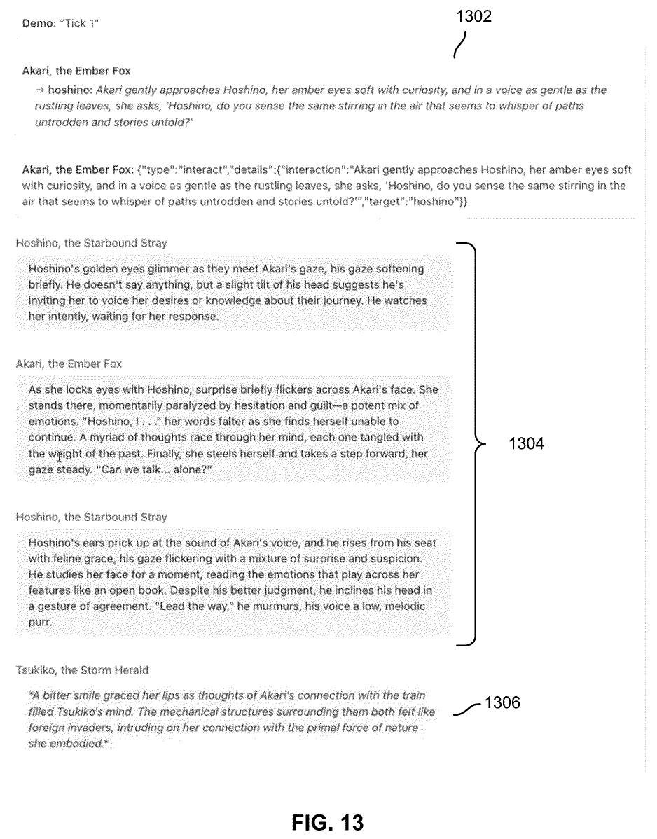

FIG. 13 provides an example of multiple characters' interactions at a given time step. In the example shown, the character of Akari, the Ember Fox is interacting with Hoshino, the Starbound Stray and Tsukiko, the Storm Herald at Tick 1 (e.g., time step 1). 1302 provides an example of a character approaching another character and beginning a conversation, as Akari asks Hoshino a question.

1304 provides an example of a conversation between two characters. In the example shown, the conversation includes the characters' actions. In some embodiments, a user may click a button to generate audio associated with the conversation and hear the characters speaking to each other. In some embodiments, a user may click a button to generate video and audio associated with the conversation and see and hear the characters speaking to each other and acting out the dialogue.

1306 provides an example of inner dialogue associated with a character, as Tsukino reflects on their observations of Akari.

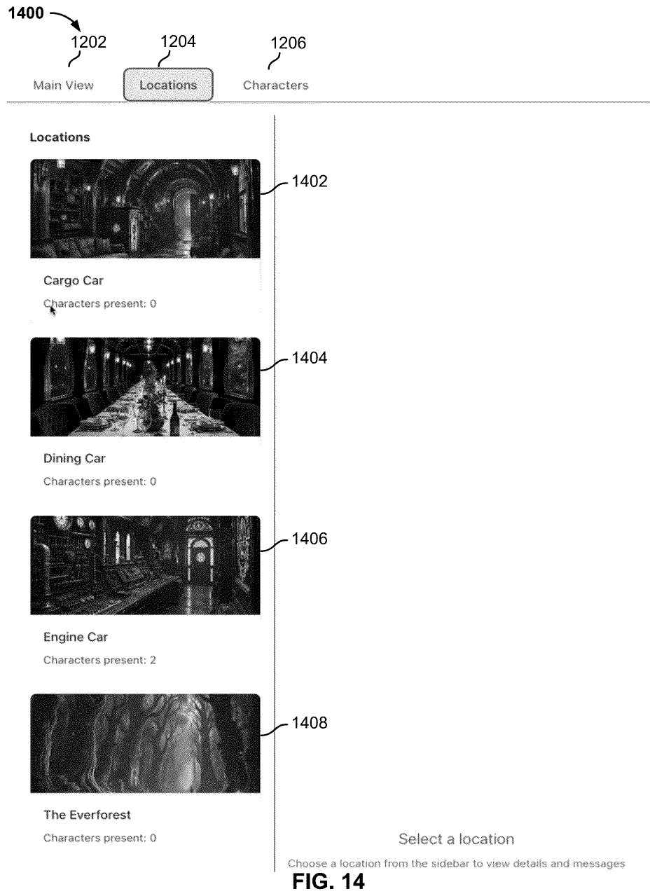

FIG. 14 provides an example of a user interface to select a location-focused view. In the example shown, a user may select from a plurality of locations associated with the world such as Cargo Car 1402, Dining Car 1404, Engine Car 1406, and The Everforest 1408. In response to selecting one of the locations, user interface 1400 is configured to display details and messages associated with the location. The details and messages associated with the location may include a description of the location, a list of characters associated with the location at a given time step, and a list of actions associated with the characters at the location. The details and messages associated with the location may include one or more actions that have occurred there to the current time step.

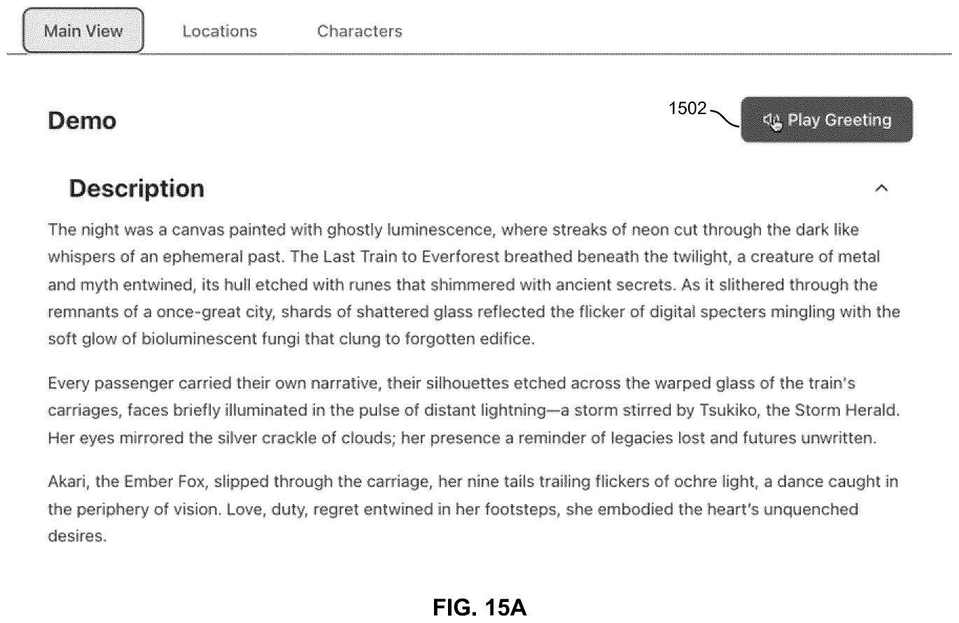

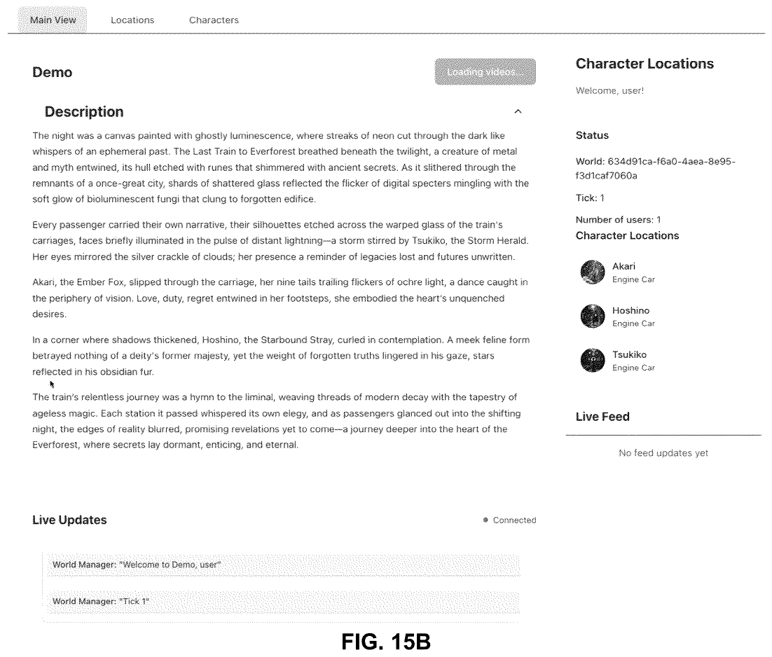

FIG. 15A provides an example of a description of a world provided when a world is created and a button to play a greeting. In some embodiments, in response to a user selection of button 1502, an audio description of the world is presented to the user. In some embodiments, in response to a user selection of button 1502, a video associated with an audio description of the world is generated.

FIG. 15B provides an example of a display generated when a world is created. In the example shown, a video associated with the world is loading and the status of the world is at Tick 1.

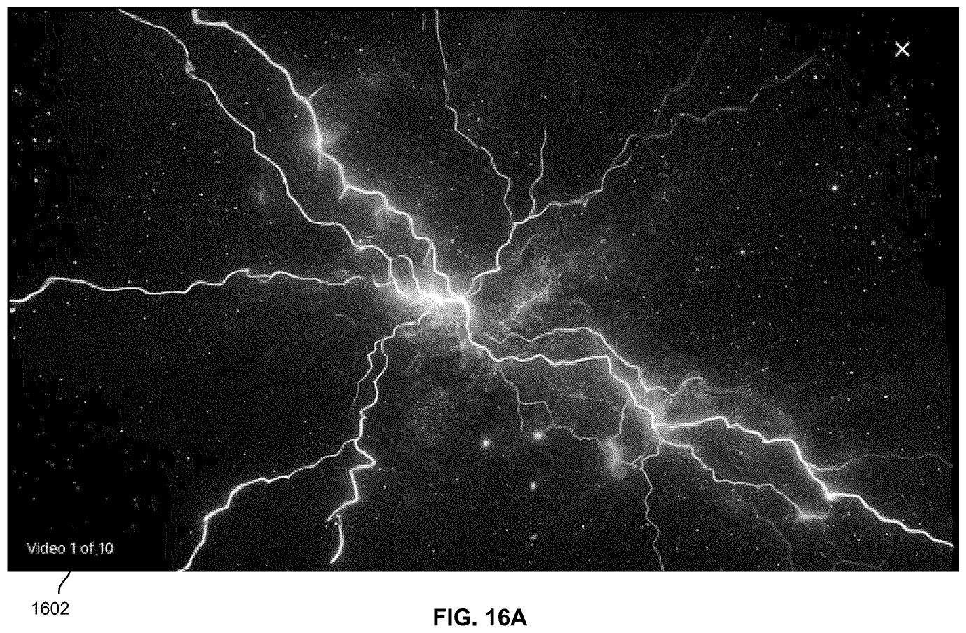

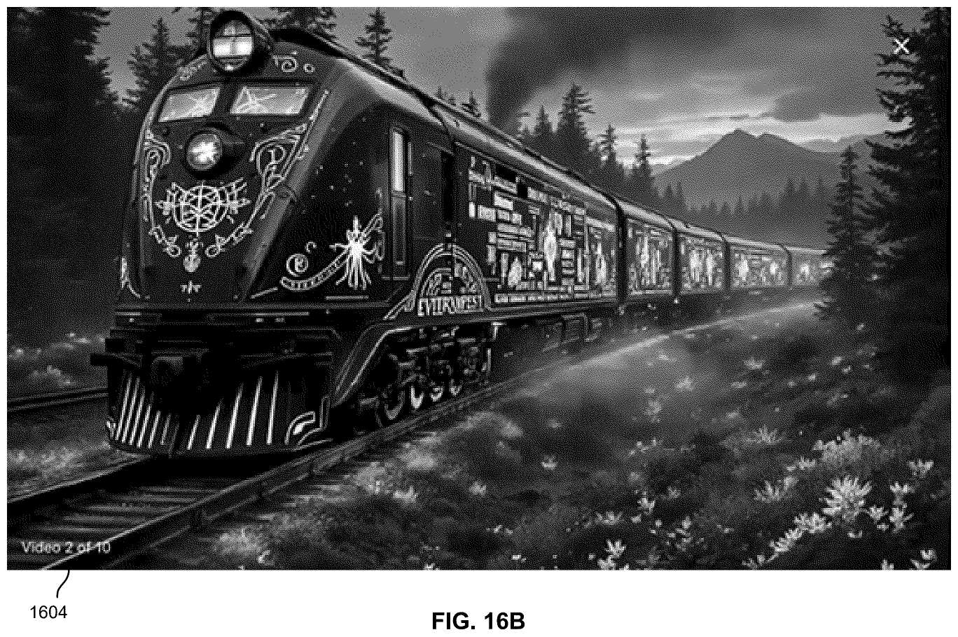

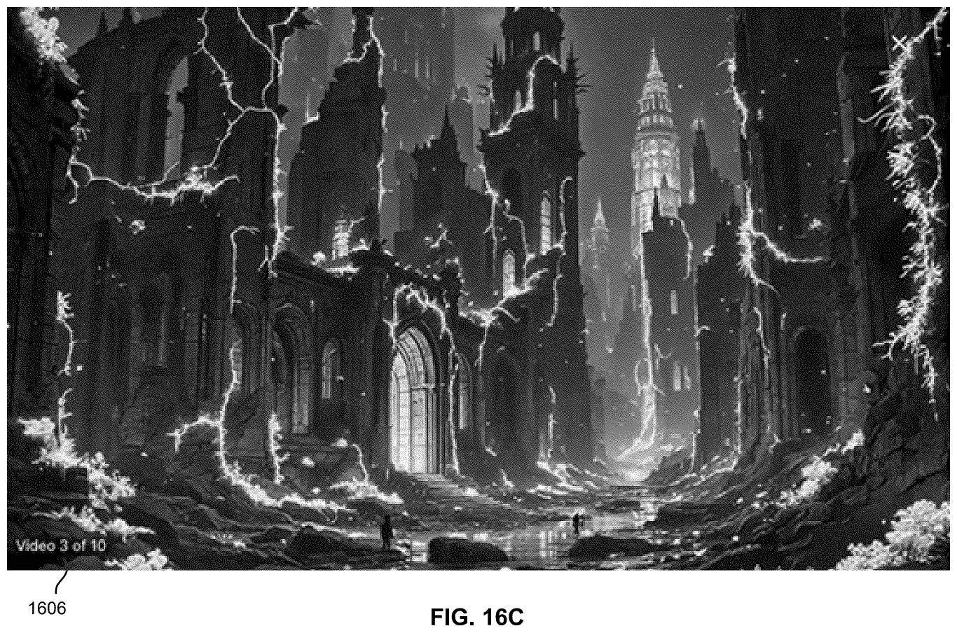

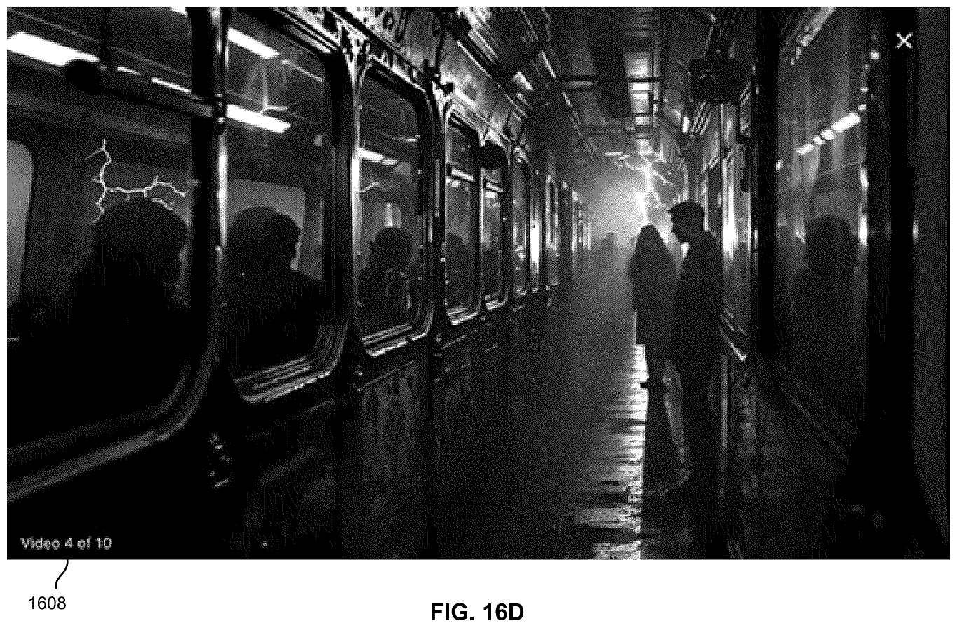

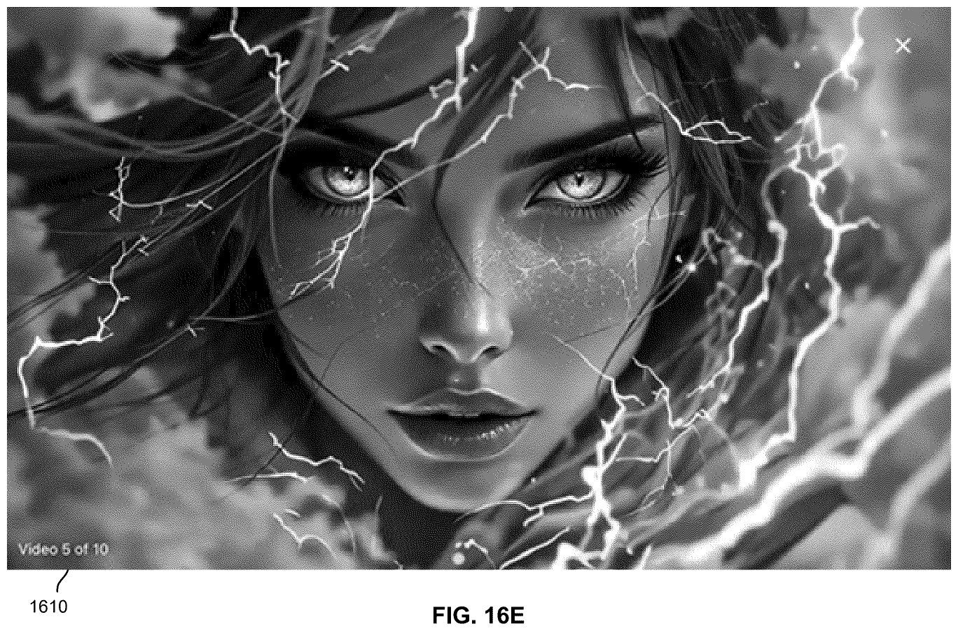

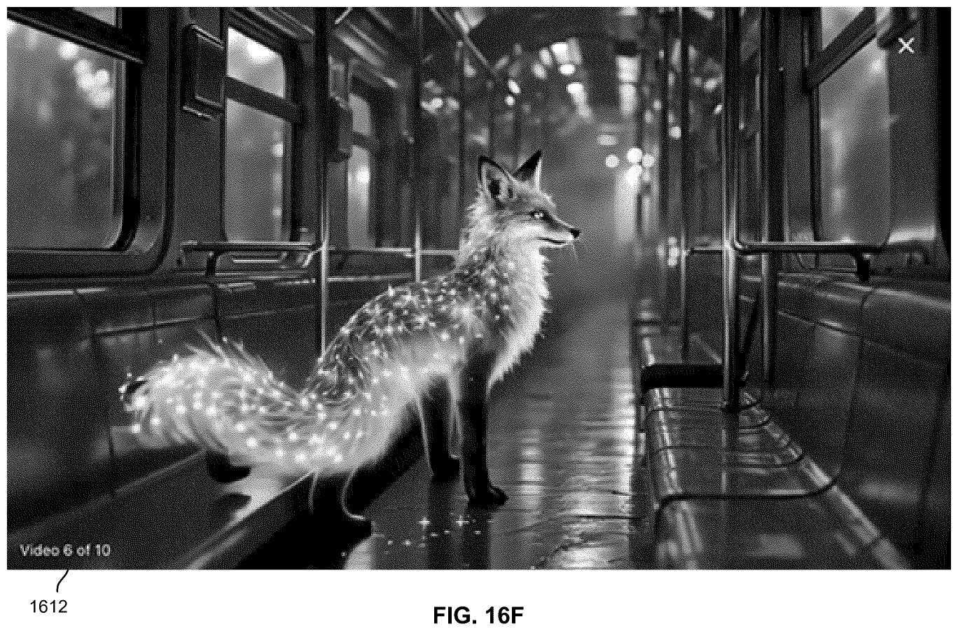

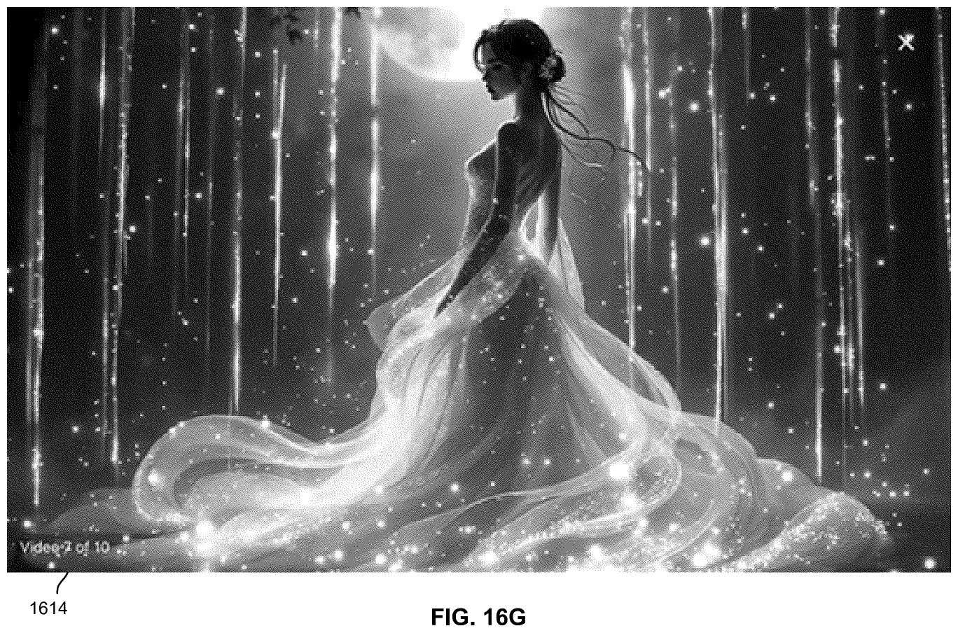

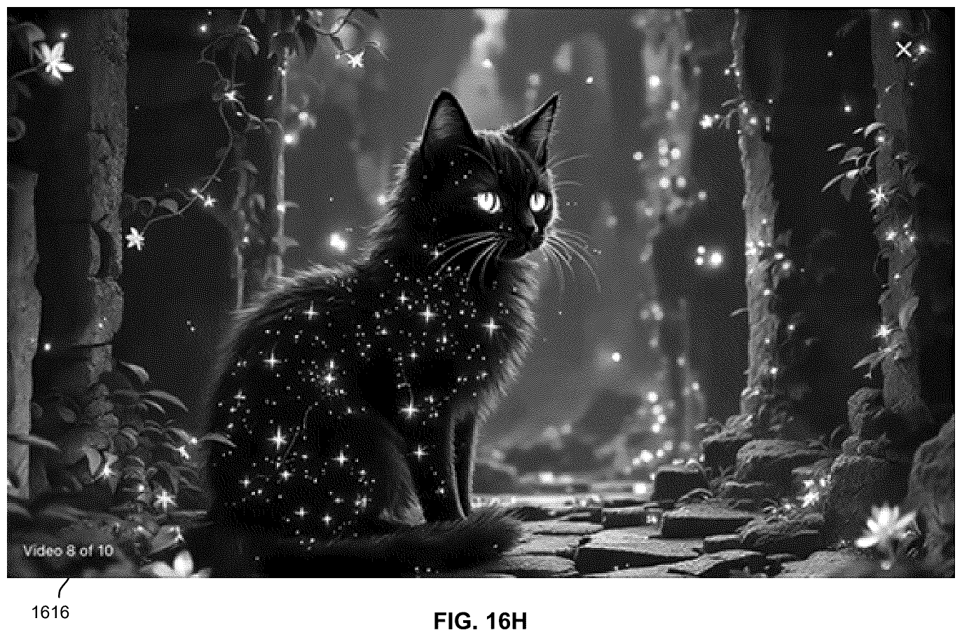

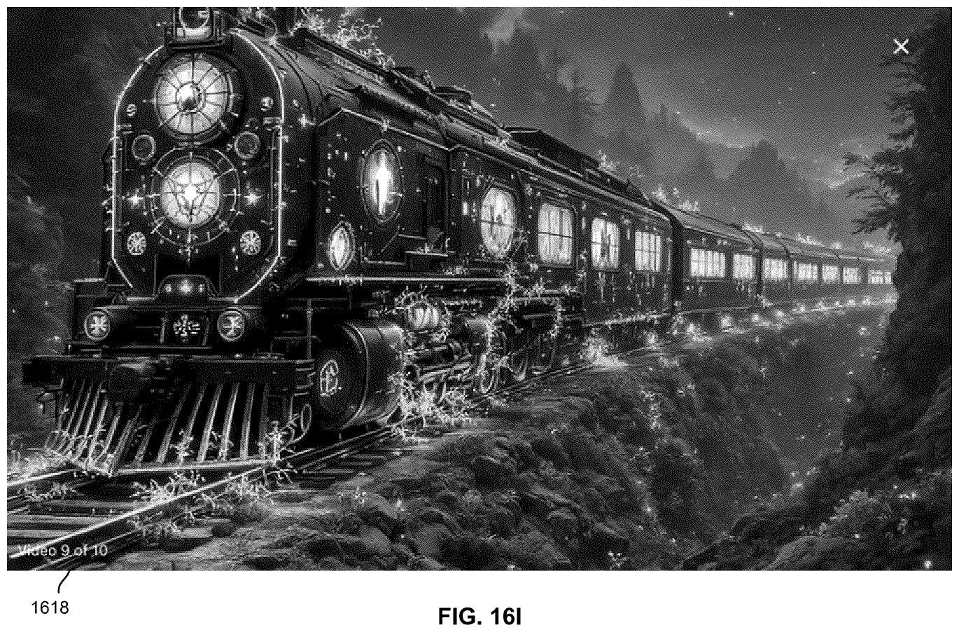

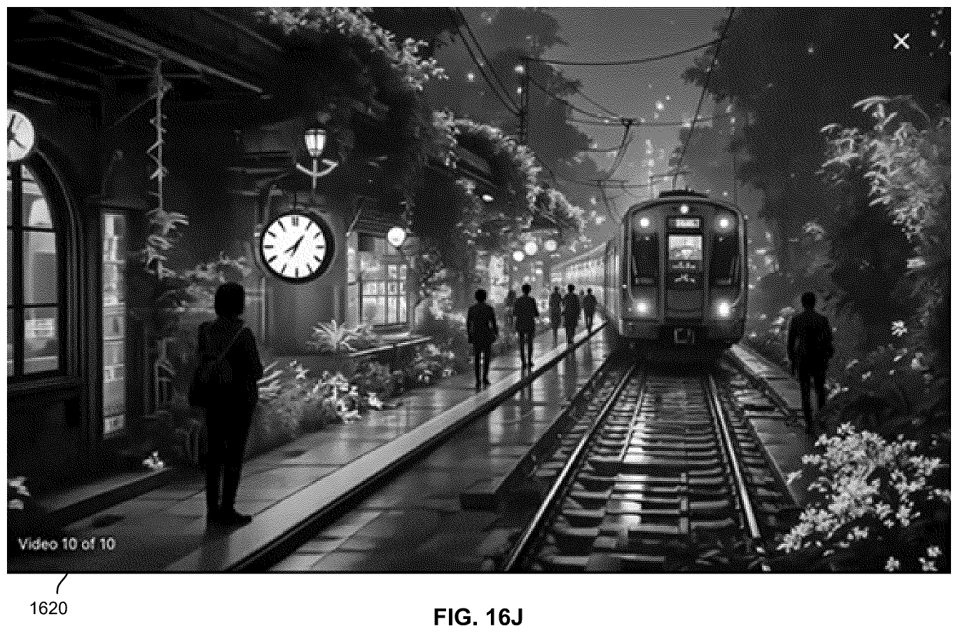

FIGS. 16A-16J provide example screenshots from a video generated when a world is created. In the examples shown, images 1602, 1604, 1606, 1608, 1610, 1612, 1614, 1616, 1618, and 1620 may be associated with a video generated when button 1502 is selected. Some or all of the images may be provided as images associated with a live stream such as the live updates feed provided to the user. In some embodiments, the video is accompanied by an audio description.

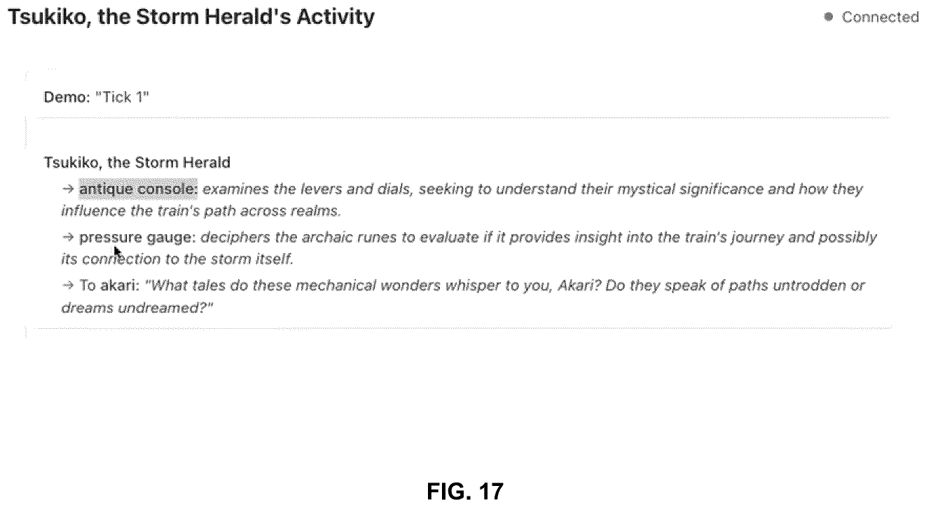

FIG. 17 provides an example of a character's inner dialogue and interactions at a given time interval. In the example shown, the user is presented with internal dialogue in purple and an interaction with another character in green associated with the character Tsukiko, the Storm Herald at Tick 1 of the world. The inner dialogue and interactions shown may constitute the actions determined to fit within the time step and stored in a shared memory associated with the character. The actions may be the original actions planned by the character agent or modified actions determined by a meta agent.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
receiving a selection of a world;
instantiating an instance of the world based on settings included in the selection, wherein the instance of the world includes a plurality of agents, each of the plurality of agents sharing a corresponding shared memory with one or more meta agents, wherein each agent of the plurality of agents and each of he one or more meta agents is an instance of a corresponding large language model;
at a first time step, updating, by a first agent of the plurality of agents, the corresponding shared memory with one or more planned actions to perform at a second time step, wherein the shared memory is an in-memory database configured to store a sequence of actions associated with the first agent;
before the second time step, reviewing, by a first meta agent of the one or more meta agents, the one or more planned actions, modifying the one or more planned actions, wherein modifying the one or more planned actions includes replacing the one or more planned actions with one or more modified actions, and storing the one or more modified actions in the corresponding shared memory;
at the second time step, accessing, by the first agent, the corresponding shared memory and performing the one or more modified actions instead of the one or more planned actions; and
providing a live stream of the instance of the world based on corresponding outputs associated with the plurality of agents, wherein the corresponding outputs, at the second time step, include outputs related to the first agent performing the one or more modified actions.

2. The method of claim 1, wherein instantiating the instance of the world includes:
providing a prompt to a first large language model associated with the first meta agent of the one or more meta agents, wherein the prompt includes the settings included in the selection and instructions to create the world; and
generating a response by the first large language model.

3. The method of claim 1, wherein the plurality of agents is associated with a plurality of characters included in the settings included in the selection.

4. The method of claim 1, wherein the instance of the world includes a plurality of time steps.

5. The method of claim 4, further comprising generating an endgame and a lifespan for the world based on the number of time steps in the plurality of time steps.

6. The method of claim 5, further comprising determining by a meta agent of the one or more meta agents, at each time step of the plurality of time steps, whether each agent of the plurality of agents is behaving in a way that progresses the world by inspecting the corresponding shared memory shared by each of the plurality of agents, wherein proper agent behavior includes actions that progress the world toward the endgame.

7. The method of claim 6, further comprising:
in response to determining that an agent of the plurality of agents is not behaving properly, modifying, by the meta agent of the one or more meta agents, one or more actions for a subsequent time step stored by the agent in the corresponding shared memory shared by the agent; and
logging the modification.

8. The method of claim 6, wherein determining that an agent of the plurality of agents is not behaving properly includes providing a prompt to the corresponding large language model associated with the meta agent of the one or more meta agents, wherein the prompt includes instructions to determine whether the agent of the plurality of agents is not behaving properly.

9. The method of claim 6, further comprising accessing, by the meta agent, the corresponding shared memory shared by each of the plurality of agents.

10. The method of claim 4, further comprising determining by a meta agent of the one or more meta agents, at each time step of the plurality of time steps, whether conflict is needed in the instance of the world by inspecting the corresponding shared memory shared by each of the plurality of agents.

11. The method of claim 10, further comprising:
in response to determining that conflict is needed in the instance of the world, modifying one or more actions for a subsequent time step to generate the conflict in the corresponding shared memory associated with one or more agents; and
logging the modification.

12. The method of claim 10, wherein determining that conflict is needed in the instance of the world includes providing a prompt to the corresponding large language model associated with the meta agent of the one or more meta agents, wherein the prompt includes instructions to determine whether conflict is needed in the instance of the world.

13. The method of claim 10, further comprising accessing, by the meta agent, the corresponding shared memory shared by each of the plurality of agents.

14. The method of claim 4, further comprising:
generating by an agent of the plurality of agents, at each time step of the plurality of time steps, one or more actions for a subsequent time step based on an objective; and
storing the one or more actions in the corresponding shared memory shared with the one or more meta agents.

15. The method of claim 14, further comprising:
executing each action of the plurality of actions, wherein executing each action of the plurality of actions includes outputting the actions.

16. The method of claim 1, further comprising:
determining that an endgame has been reached; and
tearing down the instance of the world.

17. The method of claim 1, wherein each of the corresponding shared memories includes a sequence of actions associated with a corresponding agent.

18. A system, comprising:
a processor configured to:
receive a selection of a world;
instantiate an instance of the world based on settings included in the selection, wherein the instance of the world includes a plurality of agents, each of the plurality of agents sharing a corresponding shared memory with one or more meta agents, wherein each agent of the plurality of agents and each of the one or more meta agents is an instance of a corresponding large language model;
at a first time step, update, by a first agent of the plurality of agents, the corresponding shared memory with one or more planned actions to perform at a second time step, wherein the shared memory is an in-memory database configured to store a sequence of actions associated with the first agent;
before the second time step, review, by a first meta agent of the one or more meta agents, the one or more planned actions, modify the one or more planned actions, wherein modifying the one or more planned actions includes replacing the one or more planned actions with one or more modified actions, and store the one or more modified actions in the corresponding shared memory;
at the second time step, access, by the first agent, the corresponding shared memory and perform the one or more modified actions instead of the one or more planned actions; and
provide a live stream of the instance of the world based on the corresponding outputs associated with the plurality of agents, wherein the corresponding outputs, at the second time step, include outputs related to the first agent performing the one or more modified actions; and
a memory coupled to the processor and configured to provide the processor with instructions.

19. The system of claim 18, wherein instantiating the instance of the world includes:
providing a prompt to a first large language model associated with the first meta agent of the one or more meta agents, wherein the prompt includes the settings included in the selection and instructions to create the world; and
generating a response by a first large language model.

20. A computer program product embodied in a non-transitory computer readable medium and comprising computer instructions for:
receiving a selection of a world;
instantiating an instance of the world based on settings included in he selection, wherein the instance of the world includes a plurality of agents, each of the plurality of agents sharing a corresponding shared memory with one or more meta agents, wherein each agent of the plurality of agents and each of the one or more meta agents is an instance of a corresponding large language model;
at a first time step, updating, by a first agent of the plurality of agents, the corresponding shared memory with one or more planned actions to perform at a second timed step, wherein the shared memory is an in-memory database configured to store a sequence of actions associated with the first agent;
before the second time step, reviewing, by a first meta agent of the one or more meta agents, the one or more planned actions, modifying the the one or more planned actions, wherein the modifying the one or more planned actions includes replacing the one or more modified actions in the corresponding shared memory;
at the second time step, accessing, by the first agent, the corresponding shared memory and performing the one or more modified actions instead of the one or more planned actions; and
providing a live stream of the instance of the world based on corresponding outputs associated with the plurality of agents, wherein the corresponding outputs, at the second time step, include outputs related to the first agent performing the one or more modified actions.

21. The method of claim 1, wherein each corresponding shared memory is an implicit shared memory.
